(19) United States
(12) Patent Application Publication
(10) Pub. No.: US 2004/0193851 A1
(43) Pub. Date: Sep. 30, 2004

(54) System and method for increasing program execution speed

(75) Inventor: Chih-Hsing Chu, Taipei (TW)

Correspondence Address: BACON & THOMAS, PLLC, 625 SLATERS LANE, FOURTH FLOOR, ALEXANDRIA, VA, 22314

(73) Assignee: Institute for Information Industry, Taipei (TW)

(21) Appl. No.: 10/396,493

(22) Filed: Mar. 26, 2003

(51) Int. Cl. G06F 9/44

(52) U.S. Cl. 712/226

(57) ABSTRACT

Disclosed are a system and a method for increasing speed in executing a Java program. When an instruction is fetched and if the instruction can become a fast instruction, an IP is used to search a program section in a dynamic memory for determining the quick execution data, and the instruction is executed by referring to the quick execution data. If there is no quick execution data in the dynamic memory and the instruction is stored in a random access memory, the instruction is executed and quick execution data is added to the instruction. If there is no quick execution data in the dynamic memory and the instruction is stored in a static memory, the instruction is executed, the data of the dynamic memory is altered and quick execution data is added into the dynamic memory.

### BACKGROUND OF THE INVENTION

1. Field of the Invention

The present invention relates to techniques of saving memory space and, more particularly, to an improved system and method for increasing speed in executing a Java program.

2. Description of Related Art

A Java virtual machine can increase program execution speed by altering program codes. In detail, program codes are typically stored in a memory such as DRAM (dynamic random access memory). Program codes are written into the memory again after executing. In the execution, extra information is added into the program codes for making the program codes become a more complicated fast instruction. As such, an execution speed of a program section (e.g., a function in ‘.class’ of Java language) containing the fast instruction will be increased significantly by referring to the fast instruction when executing the program section in a next time.

But this is unsatisfactory for the purpose for which the invention is concerned for the following reason: In the prior art, program codes have to be stored in DRAM. Unfortunately, a device such as cellular phone has an embedded memory (e.g., DRAM) of only about 500 KB. Furthermore, a system library takes about 110 KB and applications take about 290 KB in 500 KB of memory. In other words, only 100 KB of memory is available for use. As such, there is little memory for system operation, resulting in a lowering of overall performance.

Therefore, it is desirable to provide a novel system and method for increasing speed in executing a Java program in order to mitigate and/or obviate the aforementioned problem.

### SUMMARY OF THE INVENTION

The object of the present invention is to provide a system and method for increasing speed in executing a Java program, so as to significantly reduce memory requirement while executing the program on a Java virtual machine.

In one aspect of the present invention there is provided a system for increasing speed in executing a program, which comprises: a static memory for storing at least one system library including a plurality of system program codes each being pointed by a corresponding address index; a dynamic memory including a plurality of entries each including a first storage section for storing a first comparison value and a second storage section for storing an execution data; and an instruction pointer (IP) including an address index pointed to one of the entries and a second comparison value for comparing with the first comparison value of the pointed entry for searching a program section in the dynamic memory.

In another aspect of the present invention there is provided a method for increasing speed in executing a program comprising the steps of

A method for increasing speed in executing a program comprising the steps of: (a) fetching an instruction, and if the instruction is a non-fast instruction, executing the instruction; (b) if the instruction is a fast instruction, executing the instruction by referring to data previously added; (c) if the instruction can become a fast instruction, using an IP to search a program section in a dynamic memory for determining whether there is corresponding quick execution data in the dynamic memory; (d) if the quick execution data exists in the dynamic memory, executing the instruction by referring to the quick execution data; (e) if there is no quick execution data in the dynamic memory and the instruction is stored in a random access memory, executing the instruction and adding quick execution data to the instruction; and (f) if there is no quick execution data in the dynamic memory and the instruction is stored in a static memory, executing the instruction, altering the data of the dynamic memory and adding quick execution data into the dynamic memory.

Other objects, advantages, and novel features of the invention will become more apparent from the detailed description when taken in conjunction with the accompanying drawings.

### BRIEF DESCRIPTION OF THE DRAWINGS

FIG. 1 is a diagram schematically showing an example of a system for increasing Java program execution speed according to the invention; and

FIG. 2 is a flowchart showing a sequence of steps performed by the system of FIG. 1.

### DETAILED DESCRIPTION OF THE PREFERRED EMBODIMENT

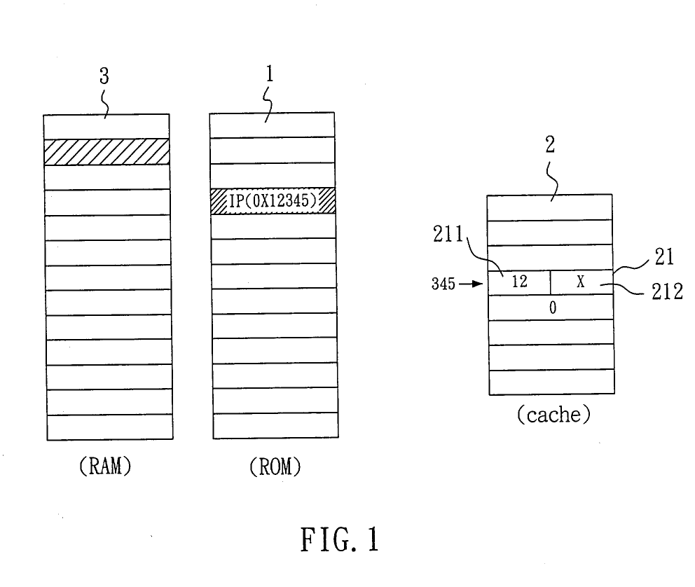

With reference to FIG. 1, there is shown a system in accordance with the invention. The system will be described in terms of execution of a Java program on a cellular phone. The system comprises a static memory 1, a dynamic memory 2 including a plurality of entries 21 each consisting of a first storage section 211 and a second storage section 212 for storing comparison data and quick execution data respectively, and a RAM (random access memory) 3.

Preferably, the static memory 1 is implemented as a ROM (read only memory) for storing a system library. Preferably, the dynamic memory 2 is implemented as a cache memory for storing quick execution data after executing the system library stored in the static memory 1. Preferably, the dynamic memory 2 has 4 KB of memory. Preferably, the entry 21 has 4B of memory. In other words, the dynamic memory 2 has 1024 entries 21. Preferably, the first storage section 211 has 1B of memory. Preferably, the second storage section 212 has 3B of memory. The RAM 3 can store program codes downloaded from the Internet or other program codes and provide a space for executing the program codes containing a fast instruction.

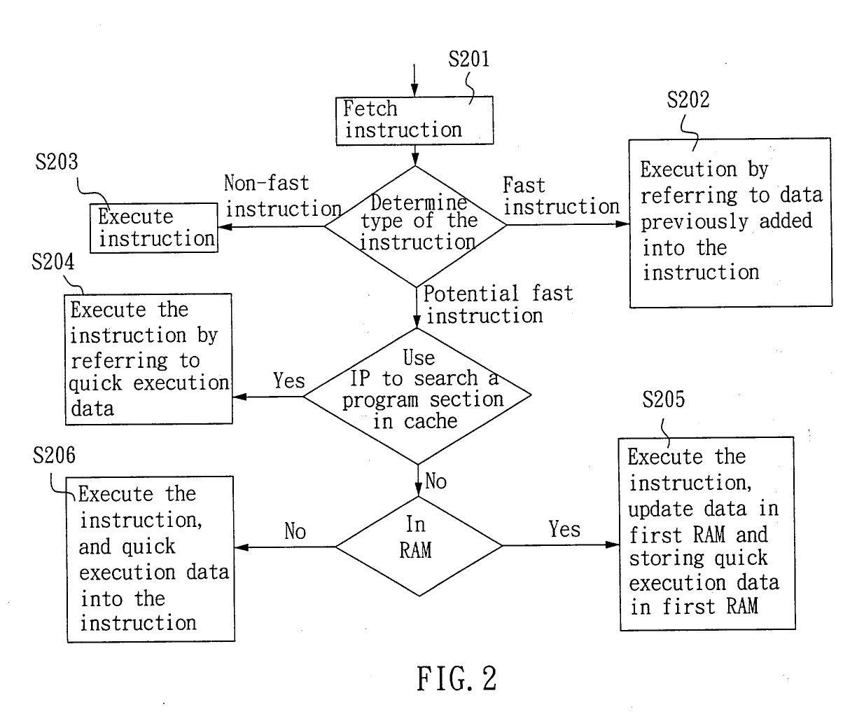

With reference to FIG. 2 in conjunction with FIG. 1, there is shown a flowchart showing a sequence of steps performed by the system. In step S201, a Java virtual machine fetches an instruction from the static memory 1 or the RAM 3 while executing a program section (e.g., a function in ‘.class’). Next, a type of the instruction is determined. If the instruction has been executed and belongs to a fast instruction set, an execution will be made immediately by referring to data previously added into the instruction (step S202). As such, an execution speed of the instruction will be increased significantly. The fast instruction set is stored in the RAM 3.

If the instruction belongs to a non-fast instruction set, the instruction will be executed in a normal speed (step S203). If the instruction has not been executed but belongs to a fast instruction set, an instruction pointer (IP) of the Java virtual machine is used to search the program section in the dynamic memory 2. The IP comprises an address index pointed to the entry 21 and a comparison data for comparing with content of the first storage section 211. Preferably, the address index occupies 10-bit (e.g., from bit 1 to bit 10) and the comparison data occupies 8-bit (e.g., from bit 11 to bit 18) respectively. For example, the IP has a value of 0x12345 in which ‘48’ is a value of the comparison data and ‘345’ is the address index pointed to the 345th entry 21. In an example, if content of the first storage section 211 at the 345th entry 21 is ‘48’, it means that the Java instruction has been executed. As such, the quick execution data in the second storage section 212 of the 345th entry 21 is executed (step S204).

If the instruction has not been executed, it is determined whether the instruction is stored in the dynamic memory 3. If not (i.e., stored in the system library of the static memory 1), the instruction is executed and both the first storage section 211 and the second storage section 212 of the 345th entry 21 are updated. For example, the value of the comparison data of the first storage section 211 is changed as ‘48’ and the quick execution data is added into the second storage section 212. In another example, if content of the first storage section 211 at the 345th entry 21 is not 48, it means that a quick execution data has been added into the entry 21 previously. Thus, both the first storage section 211 and the second storage section 212 are updated after executing the instruction (step S205).

If the instruction is stored in the RAM 3, the instruction is executed and updated as a fast instruction set by adding quick execution data into it. As such, the instruction can be executed directly in a next time for increasing program execution speed (step S206). In the embodiment, a hit ratio of at least 97% with respect to non-fast instruction set is achieved. Moreover, a hit ratio of at least 98% is made possible by storing quick execution data and non-quick execution data in two different memories.

Although the present invention has been explained in relation to its preferred embodiment, it is to be understood that many other possible modifications and variations can be made without departing from the spirit and scope of the invention as hereinafter claimed.

What is claimed is:

1. A system for increasing speed in executing a program comprising:
a static memory for storing at least one system library including a plurality of system program codes each being pointed by a corresponding address index;
a dynamic memory including a plurality of entries each including a first storage section for storing a first comparison value and a second storage section for storing an execution data; and
an instruction pointer (IP) including an address index pointed to one of the entries and a second comparison value for comparing with the first comparison value of the pointed entry for searching a program section in the dynamic memory.

2. The system as claimed in claim 1, wherein the static memory is a ROM.

3. The system as claimed in claim 1, wherein the dynamic memory is a cache memory.

4. The system as claimed in claim 1, further comprising a RAM (random access memory) for storing program codes downloaded from the Internet and associated program codes and providing a space for executing the program codes.

5. The system as claimed in claim 4, wherein the program codes and the associated program codes are Java program codes.

6. A method for increasing speed in executing a program comprising the steps of:
(a) fetching an instruction, and if the instruction is a non-fast instruction, executing the instruction;
(b) if the instruction is a fast instruction, executing the instruction by referring to data previously added;
(c) if the instruction can become a fast instruction, using an IP to search a program section in a dynamic memory for determining whether there is corresponding quick execution data in the dynamic memory;
(d) if the quick execution data exists in the dynamic memory, executing the instruction by referring to the quick execution data;
(e) if there is no quick execution data in the dynamic memory and the instruction is stored in a random access memory, executing the instruction and adding quick execution data to the instruction; and
(f) if there is no quick execution data in the dynamic memory and the instruction is stored in a static memory, executing the instruction, altering the data of the dynamic memory and adding quick execution data into the dynamic memory.

7. The method as claimed in claim 6, wherein the instruction is a Java instruction.

8. The method as claimed in claim 6, wherein the random access memory is a cache memory.
